(19) United States
(12) Patent Application Publication
(10) Pub. No.: US 2026/0096873 A1
(43) Pub. Date: Apr. 9, 2026

(54) SYSTEMS AND METHODS FOR MAPPING GINGIVAL SURFACE

(71) Applicant: ClaroNav Inc., North York (CA)

(72) Inventors: Doron DEKEL, Toronto (CA); Razvan MITULESCU, Toronto (CA)

(21) Appl. No.: 19/416,943

(22) Filed: Dec. 11, 2025

Related U.S. Application Data
(63) Continuation of application No. PCT/CA2024/050836, filed on Jun. 21, 2024.
(60) Provisional application No. 63/522,488, filed on Jun. 22, 2023.

(51) Int. Cl. A61C 13/00; A61C 9/00; G06T 7/00; G06T 7/73

(52) U.S. Cl. CPC A61C 13/0004; A61C 9/008; G06T 7/0014; G06T 7/74; G06T 2207/30036; G06T 2207/30204

(57) ABSTRACT

A method of mapping a gingival surface of a patient's jaw using at least one spatially trackable reference object in a fixed spatial relation to that jaw and a spatially trackable mapping tool. A plurality of gingival surface coordinate sets are captured in a coordinate frame of the jaw. Each of the gingival surface coordinate sets is captured when the mapping tool is in contact with a corresponding gingival surface location on the gingival surface. A geometrical gingival surface descriptor is computed from the plurality of gingival surface coordinate sets.

### CROSS-REFERENCE TO RELATED APPLICATION

This application is a continuation of PCT/CA2024/050836, filed Jun. 21, 2024, which claims the benefit of U.S. Provisional Ser. No. 63/522,488 , filed Jun. 22, 2023, each of which is incorporated herein by reference in its entirety.

### FIELD

This document relates generally to medical devices, in particular, dental prosthetics systems and methods.

### BACKGROUND

The following is not an admission that anything discussed below is part of the prior art or part of the common general knowledge of a person skilled in the art.

Designing and manufacturing a dental prosthetic requires an understanding of the underlying surface to which the dental prosthetic will be mounted. Computer-aided digital design (CAD) of a dental prothesis relies on a digital map of the surfaces within a patient's mouth. The digital map is typically obtained using an intraoral scanner (IOS). While IOS systems excel at mapping the surfaces of teeth, they are not as well adapted for mapping gingival surfaces. IOS systems often encounter challenges in mapping gingival surfaces, particularly in the presence of obstructions such as blood, saliva, loose tissue flaps and sutures. The resulting digital map may then provide an inaccurate representation of the mounting surfaces for the dental prosthesis, which can lead to an ill-fitting prosthesis.

### SUMMARY

The following introduction is provided to introduce the reader to the more detailed discussion to follow. The introduction is not intended to limit or define any claimed or as yet unclaimed invention. One or more inventions may reside in any combination or sub-combination of the elements or process steps disclosed in any part of this document including its claims and figures.

In accordance with an aspect of this disclosure, there is provided a method of mapping the gingival surfaces within a patient's mouth using a mapping tool that can be placed in contact with the gingival surfaces. The mapping tool can be spatially tracked, allowing the coordinates of a gingival surface location to be identified based on the pose of the mapping tool when the mapping tool is contacting the gingival surface location. This can allow the gingival surface locations to be accurately mapped even in the presence of obstructions such as blood, saliva, loose tissue flaps and sutures.

Coordinates for multiple gingival surface locations can be acquired when the mapping tool is in contact with the respective gingival surface locations. These coordinates can be defined in, or converted to, a coordinate frame of the patient's jaw to provide a consistent frame of reference to define the gingival surface. A surface descriptor of the gingival surface can then be computed from the gingival surface coordinate sets.

The surface descriptor can be used to guide the design of the intaglio (interior) mounting surface of a prosthesis. The surface descriptor can also be used to generate and render a digital map of the gingival surface, to allow a practitioner to review and possibly refine the surface descriptor by acquiring coordinate sets from additional surface locations.

In accordance with this aspect, there is provided a method of mapping a gingival surface of a patient's jaw using at least one spatially trackable reference object in a fixed spatial relation to that jaw and a spatially trackable mapping tool, the method comprising: capturing a plurality of gingival surface coordinate sets in a coordinate frame of the jaw, wherein each of the gingival surface coordinate sets is captured when the mapping tool is in contact with a corresponding gingival surface location on the gingival surface; and computing a geometrical gingival surface descriptor from the plurality of gingival surface coordinate sets.

The plurality of gingival surface coordinates can include at least four gingival surface coordinate sets corresponding to at least four gingival surface locations along a crestline of the gingival surface.

Each spatially trackable reference object can be rigidly coupled to the bone of the patient's jaw.

A plurality of spatially trackable reference objects can be coupled to the bone of the patient's jaw and two different subsets of the reference objects can be used in capturing the plurality of gingival surface coordinate sets.

At least one spatially trackable reference object can be coupled to a prothesis coupling region of a dental implant assembly.

The method can include capturing a plurality of coupling region poses in the coordinate frame of the jaw, the plurality of coupling region poses corresponding to a plurality of a dental prosthesis coupling regions of a dental implant assembly; and defining the geometrical gingival surface descriptor to include geometrical representations of the prosthesis coupling regions.

The gingival surface descriptor can be defined to approximate intermediary portions of the gingival surface between the gingival surface locations corresponding to the plurality of gingival surface coordinate sets.

The gingival surface descriptor can be defined to include a plurality of mapped crestline surface locations corresponding to at least four gingival surface locations along a crestline of the gingival surface, and the intermediary portions of the gingival surface can be approximated using a modelled crestline curve determined to pass through or proximate to each of the mapped crestline surface locations.

Computing the geometrical gingival surface descriptor can include: computing an initial geometrical gingival surface descriptor; subsequently capturing at least one additional gingival surface coordinate set in the coordinate frame of the jaw; and computing an updated geometrical gingival surface descriptor by updating the initial geometrical gingival surface descriptor using the at least one additional gingival surface coordinate set.

The method can include, for each spatially trackable reference object, determining an object-specific mapping between an object coordinate frame of that spatially trackable reference object and the jaw coordinate frame.

The mapping tool can include a surface locator portion usable to contact the gingival surface, where the surface locator portion has an extended surface contact section shaped to extend across an extended section of the gingival surface when the surface locator portion is positioned at a given gingival surface location.

The extended surface contact section can be rotatable while maintaining a fixed relationship between the surface locator portion and an optically trackable marker on the mapping tool.

The method can include rendering a 3-dimensional digital gingival surface map from the geometrical gingival surface descriptor and displaying the 3-dimensional digital gingival surface map.

The method can include guiding design of an intaglio surface of a dental prothesis using the geometrical gingival surface descriptor.

Capturing the plurality of gingival surface coordinate sets can include, for each gingival surface coordinate set, capturing an image of the spatially trackable mapping tool and at least one of the spatially trackable reference objects while the mapping tool is in contact with the corresponding gingival surface location on the gingival surface.

Capturing the plurality of gingival surface coordinate sets can include, for each gingival surface coordinate set: determining an object reference surface coordinate set in an object coordinate frame of the at least one of the spatially trackable reference objects; and determining the gingival surface coordinate set by mapping the object reference surface coordinate set from the object coordinate frame into the jaw coordinate frame.

In accordance with an aspect of this disclosure, there is provided a system for mapping a gingival surface of a patient's jaw using at least one spatially trackable reference object in a fixed spatial relation to that jaw and a spatially trackable mapping tool, the system comprising: at least one image sensor; and at least one processor; wherein the at least one image sensor is configured to capture a plurality of gingival surface coordinate sets in a coordinate frame of the jaw, wherein each of the gingival surface coordinate sets is captured when the mapping tool is in contact with a corresponding gingival surface location on the gingival surface; and the at least one processor is configured to compute a geometrical gingival surface descriptor from the plurality of gingival surface coordinate sets.

The plurality of gingival surface coordinates can include at least four gingival surface coordinate sets corresponding to at least four gingival surface locations along a crestline of the gingival surface.

Each spatially trackable reference object can be rigidly coupled to the bone of the patient's jaw.

The system can include a plurality of spatially trackable reference objects coupled to the bone of the patient's jaw; and the at least one image sensor can be configured to capture a first gingival surface coordinate set using a first subset of the reference objects and to capture a second gingival surface coordinate set using a second subset of the reference objects.

The system can include at least one spatially trackable reference object coupled to a prothesis coupling region of a dental implant assembly.

The at least one image sensor can be configured to capture a plurality of coupling region poses in the coordinate frame of the jaw, the plurality of coupling region poses corresponding to a plurality of a dental prosthesis coupling regions of a dental implant assembly; and the at least one processor can be configured to define the geometrical gingival surface descriptor to include geometrical representations of the prosthesis coupling regions.

The at least one processor can be configured to define the gingival surface descriptor to approximate intermediary portions of the gingival surface between the gingival surface locations corresponding to the plurality of gingival surface coordinate sets.

The at least one processor can be configured to define the gingival surface descriptor to include a plurality of mapped crestline surface locations corresponding to at least four gingival surface locations along a crestline of the gingival surface, and the intermediary portions of the gingival surface can be approximated using a modelled crestline curve determined to pass through or proximate to each of the mapped crestline surface locations.

The at least one processor can be configured to compute the geometrical gingival surface descriptor by: computing an initial geometrical gingival surface descriptor; subsequently receiving at least one additional gingival surface coordinate set in the coordinate frame of the jaw; and computing an updated geometrical gingival surface descriptor by updating the initial geometrical gingival surface descriptor using the at least one additional gingival surface coordinate set.

The at least one processor can be further configured to, for each spatially trackable reference object, determine an object-specific mapping between an object coordinate frame of that spatially trackable reference object and the jaw coordinate frame.

The system can include the mapping tool, where the mapping tool can include a surface locator portion usable to contact the gingival surface, where the surface locator portion has an extended surface contact section shaped to extend across an extended section of the gingival surface when the surface locator portion is positioned at a given gingival surface location.

The extended surface contact section can be rotatable while maintaining a fixed relationship between the surface locator portion and an optically trackable marker on the mapping tool.

The at least one processor can be further configured to render a 3-dimensional digital gingival surface map from the geometrical gingival surface descriptor and display the 3-dimensional digital gingival surface map.

The at least one processor can be further configured to guide design of an intaglio surface of a dental prothesis using the geometrical gingival surface descriptor.

The at least one image sensor can be configured to capture the plurality of gingival surface coordinate sets by, for each gingival surface coordinate set, capturing an image of the spatially trackable mapping tool and at least one of the spatially trackable reference objects while the mapping tool is in contact with the corresponding gingival surface location on the gingival surface.

The at least one image sensor can be configured to capture the plurality of gingival surface coordinate sets by, for each gingival surface coordinate set: determining an object reference surface coordinate set in an object coordinate frame of the at least one of the spatially trackable reference objects; and determining the gingival surface coordinate set by mapping the object reference surface coordinate set from the object coordinate frame into the jaw coordinate frame.

In accordance with an aspect of this disclosure, there is provided a non-transitory computer readable medium storing computer-executable instructions for configuring one or more processors to perform a method of mapping a gingival surface of a patient's jaw using at least one spatially trackable reference object in a fixed spatial relation to that jaw and a spatially trackable mapping tool, the method comprising: acquiring a plurality of gingival surface coordinate sets in a coordinate frame of the jaw, wherein each of the gingival surface coordinate sets is captured when the mapping tool is in contact with a corresponding gingival surface location on the gingival surface; and computing a geometrical gingival surface descriptor from the plurality of gingival surface coordinate sets.

The non-transitory computer readable medium can include instructions for configuring the one or more processors to perform the method of mapping a gingival surface as described herein.

It will be appreciated by a person skilled in the art that an apparatus, system, or method disclosed herein may embody any one or more of the features contained herein and that the features may be used in any particular combination or sub-combination.

These and other aspects and features of various examples will be described in greater detail below.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1A is a diagram illustrating a perspective view of an example gingival surface;

FIG. 1B is a diagram illustrating a perspective view of an example gingival surface map corresponding to the example gingival surface shown in FIG. 1A;

FIG. 2 is a block diagram of an example system for mapping a gingival surface;

FIG. 3 is a flowchart illustrating an example method of mapping a gingival surface;

FIG. 4 is a flowchart illustrating an example method of mapping gingival surface locations into a jaw coordinate frame;

FIG. 5 is a diagram illustrating a perspective view of an example gingival surface descriptor;

FIG. 6 is a diagram illustrating a perspective view of an example rendering of a gingival surface map;

FIG. 7 is a diagram illustrating a perspective view of another example gingival surface descriptor including additional gingival sample locations; and

FIG. 8 is a diagram illustrating a perspective view of an example mapping tool that can be used with the example system shown in FIG. 2.

### DETAILED DESCRIPTION

Various apparatuses or processes or compositions will be described below to provide an example of the claimed subject matter. No example described below limits any claim and any claim may cover processes or apparatuses or compositions that differ from those described below. The claims are not limited to apparatuses or processes or compositions having all of the features of any one apparatus or process or composition described below or to features common to multiple or all of the apparatuses or processes or compositions described below. It is possible that an apparatus or process or composition described below is not an example of any exclusive right granted by issuance of this patent application. Any subject matter described below and for which an exclusive right is not granted by issuance of this patent application may be the subject matter of another protective instrument, for example, a continuing patent application, and the applicants, inventors, or owners do not intend to abandon, disclaim, or dedicate to the public any such subject matter by its disclosure in this document.

For simplicity and clarity of illustration, reference numerals may be repeated among the figures to indicate corresponding or analogous elements. In addition, numerous specific details are set forth in order to provide a thorough understanding of the subject matter described herein. However, it will be understood by those of ordinary skill in the art that the subject matter described herein may be practiced without these specific details. In other instances, well-known methods, procedures, and components have not been described in detail so as not to obscure the subject matter described herein. The description is not to be considered as limiting the scope of the subject matter described herein.

The terms “coupled” or “coupling” as used herein can have several different meanings depending on the context in which these terms are used. For example, the terms coupled or coupling can have a mechanical, electrical, or communicative connotation. For example, as used herein, the terms coupled or coupling can indicate that two elements or devices can be directly connected to one another or connected to one another through one or more intermediate elements or devices via an electrical element, electrical signal, or a mechanical element depending on the particular context. Furthermore, the term “communicative coupling” may be used to indicate that an element or device can electrically, optically, or wirelessly send data to another element or device as well as receive data from another element or device.

As used herein, the wording “and/or” is intended to represent an inclusive-or. That is, “X and/or Y” is intended to mean X or Y or both, for example. As a further example, “X, Y, and/or Z”is intended to mean X or Y or Z or any combination thereof.

Terms of degree such as “substantially”, “about”, and “approximately” as used herein mean a reasonable amount of deviation of the modified term such that the end result is not significantly changed. These terms of degree may also be construed as including a deviation of the modified term if this deviation would not negate the meaning of the term it modifies.

Any recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

Some elements that are used to implement at least part of the systems, methods, and devices described herein may be implemented via software that is written in a high-level procedural language such as object oriented programming. Accordingly, the program code may be written in any suitable programming language such as Python or C for example. Alternatively, or in addition thereto, some of these elements implemented via software may be written in assembly language, machine language or firmware as needed. In either case, the language may be a compiled or interpreted language.

At least some of these software programs may be stored on a storage media (e.g. a computer readable medium such as, but not limited to, ROM, magnetic disk, optical disc) or a device that is readable by a general or special purpose programmable device. The software program code, when read by the programmable device, configures the programmable device to operate in a new, specific and predefined manner in order to perform at least one of the methods described herein.

Furthermore, at least some of the programs associated with the systems and methods described herein may be capable of being distributed in a computer program product comprising a computer readable medium that bears computer usable instructions for one or more processors. The medium may be provided in various forms, including non-transitory forms such as, but not limited to, one or more diskettes, compact disks, tapes, chips, and magnetic and electronic storage. Alternatively, the medium may be transitory in nature such as, but not limited to, wire-line transmissions, satellite transmissions, internet transmissions (e.g. downloads), media, digital and analog signals, and the like. The computer useable instructions may also be in various formats, including compiled and non-compiled code.

The present disclosure relates to systems and methods for mapping gingival surfaces within a patient's mouth. The systems and methods described herein can be used to provide a geometrical surface descriptor of the gingival surface even in the presence of obstructions such as blood or loose gum flaps for example. The geometrical surface descriptor can be used, for example, to guide the design of a dental prosthesis to be implanted in a patient's mouth.

When a patient is fitted with a dental prosthesis, the interior mounting surface of the prosthesis should be shaped to fit over the gingival surfaces and the mounting elements within the patient's mouth. The interior/intaglio surface (the surface facing the gingiva) of the prosthesis should be shaped to accommodate the shape of the gingival surface and any aberrations in, or projections from, the gingival surface such as mounting elements (e.g. abutments) positioned within the mouth, any teeth within the patient's mouth etc.

Contact between the dental prosthesis and the gingiva is typically limited to a narrow strip along the crestline (also referred to as ridgeline or midline), of the gingiva. The intaglio surface of the dental prosthesis is thus typically designed to be substantially flattened or slightly convex to facilitate access to the intaglio surface and underlying gingiva to allow for cleaning of those surfaces. The systems and methods described herein can provide a geometrical surface descriptor of the gingival surface including the crestline and the poses of mounting elements embedded therein to facilitate the design and manufacture of a well-fitting prosthetic.

The systems and methods described herein can also be used to map the outwardly facing gingival surfaces near the crestline. In particular, the facial and/or lingual/palatal gingival surfaces in the vicinity of the crestline can be mapped and included in the geometrical surface descriptor. This may help ensure that the prosthetic can be designed to provide a seamless visual aesthetic when implanted in the patient's mouth.

Computer-aided digital design of a dental prosthesis requires digital data that describes the pose of the mounting elements and the gingival surfaces surrounding those mounting elements. In existing systems, the relative poses of the mounting elements are captured using a dental photogrammetry system while the gingival surface descriptor is obtained using an intraoral scanner (IOS). However, existing systems tend to have a number of drawbacks.

In particular, IOS systems are adapted to map the surfaces of teeth, rather than gingival surfaces. Using an IOS system to map the gingival surface can be challenging in the presence of obstructions such as blood, saliva, loose tissue flaps and sutures. This can result in a gingival surface descriptor that is insufficiently accurate to guide the design of a well-fitting dental prosthesis.

Furthermore, existing approaches use separate imaging systems (an IOS and a dental photogrammetry system) to determine the pose of the mounting elements and to determine the surface descriptor of the gingival surface. In order to generate a combined geometric surface descriptor that includes both the gingival surface descriptor and the MUA poses, an additional registration process is required to align the gingival surface descriptor (from the IOS system) with the mounting element poses (from the dental photogrammetry system). This increases the complexity of the mapping process and can introduce further inaccuracies into the combined surface descriptor.

The present disclosure can provide a simplified process for mapping the gingival surfaces within a patient's mouth. For example, a single imaging system can measure the relative poses of the mounting elements and gingival surface locations. This can allow the poses of the mounting elements and the gingival surface locations to be readily determined in the same coordinate system. This eliminates the need to register two separate surface descriptors to one another in order to obtain a combined geometric surface descriptor.

The systems and methods described herein can also provide a more accurate geometric surface descriptor of the gingival surfaces. In particular, the gingival surface locations can be mapped using a mapping tool positioned to contact the gingival surface. This allows a user to accurately map those surface locations even in the presence of obstructions such as skin flaps or blood that may otherwise inhibit the mapping process when using an IOS system.

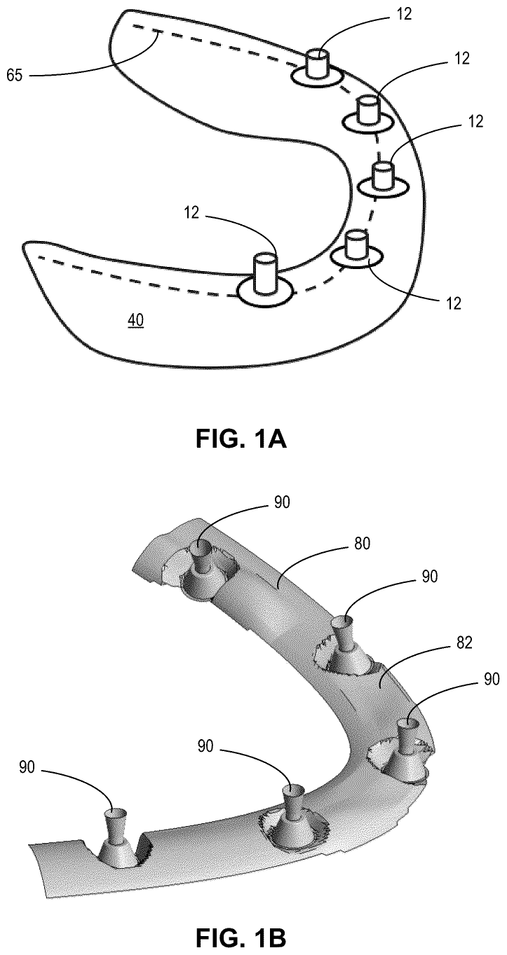

Referring now to FIG. 1A, shown therein is an illustration of an example gingival surface 40 of a jaw. The example jaw shown in FIG. 1A is fully edentulous (toothless), although it should be understood that the present disclosure can be applied equally to a partially edentulous jaw. The jaw shown in FIG. 1A is an example of a jaw in which a dental prosthesis may be implanted.

To enable the design of a dental prosthesis that will fit well on a given jaw, the interior of the dental prosthesis should ideally be designed to match or follow closely the gingival surface 40 and any teeth and/or mounting elements positioned along the gingival surface 40.

As described in further detail below, the present disclosure relates to systems and methods for mapping a gingival surface within a patient's mouth. The systems and methods for gingival surface mapping described herein can be used to generate a digital geometric surface descriptor representing the gingival surface 40. The digital surface descriptor can be defined with sufficient accuracy to guide the design of a dental prosthesis with an intaglio surface shaped to fit the gingival surface 40.

As shown in FIG. 1A, a plurality of dental prosthesis coupling regions 12 can be positioned along the gingival surface 40. The dental prosthesis coupling regions 12 can be provided by the occlusion-facing regions of mounting elements such as multi-unit abutments (MUAs). To enable mounting of the dental prosthesis to the jaw, the interior of the dental prosthesis should be shaped to align with the dental prosthesis coupling regions 12 as well as the surrounding gingival surface 40.

As can be seen in FIG. 1A, the coupling regions 12 tend to be positioned along, or proximate to, the crestline 65 of the gingival surface 40 (i.e. the highest points along the gingival surface 40). Furthermore, the prosthesis is typically designed to only, or mainly, contact the gingival surface 40 along the crestline 65 to allow access to the intaglio surface of the prosthesis and the underlying gingival surface 40 to facilitate cleaning. Accordingly, obtaining an accurate map of the crestline 65 is important to ensure that a dental prosthesis can be mounted snugly to the jaw. As a result, the gingival surface 40 may optionally be mapped using surface sample locations that are located primarily (at least initially) along the crestline 65.

Referring now to FIG. 1B, shown therein is a digital surface descriptor 80 corresponding to the gingival surface 40 shown in FIG. 1A. The digital surface descriptor 80 shown in FIG. 1B is an example of a surface descriptor that can be used to guide the computer-aided design of the intaglio surface of a dental prosthesis intended to fit along the gingival surface 40 of the patient's jaw.

The digital surface descriptor 80 can be defined using various surface representation techniques, for instance using a polygon mesh such as a triangular mesh for example. As shown in FIG. 1B, the surface descriptor 80 can also include coupling region representations 90 corresponding to the coupling regions 12 positioned along the gingival surface 40.

The coupling region representations 90 can be positioned along a crestline strip 82 defined to correspond to the crestline 65 of surface 40. The width of the crestline strip 82 can be defined to represent a standard gingival upper surface width, e.g. in a range of about 6 mm to about 12 mm.

The coupling region representations 90 can be defined to represent mounting elements, such as screw channels for example. As shown in the example of FIG. 1B, the coupling region representations 90 can be defined to include a conic cavity along the crestline strip 82 with a mounting element (e.g. a screw channel) positioned within the conic cavity. Optionally, the specific shape of the coupling region representations 90 can be selected from a plurality of potential coupling region representations 90, e.g. to represent the shape of the actual mounting elements to be used in the prosthesis being designed.

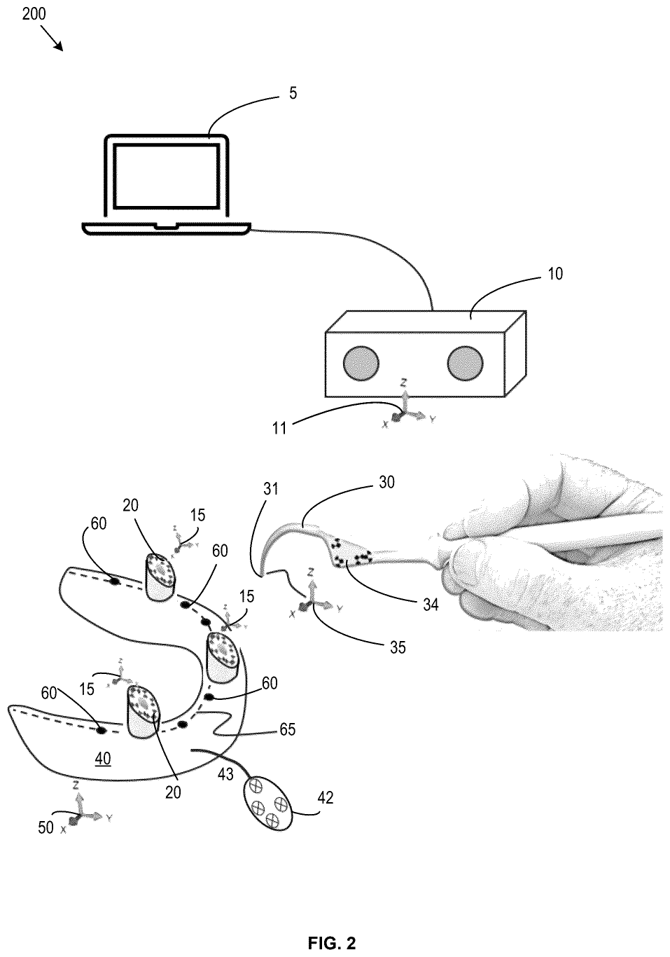

Referring now to FIG. 2, shown therein is a block diagram illustrating an example gingival mapping system 200. System 200 is an example of a system for mapping the gingival surface 40 of a patient's jaw. System 200 can be used to define a digital surface descriptor of the gingival surface. The digital surface descriptor may then be output (e.g. to a CAD application, to non-volatile storage memory and/or to a display device) to allow a user to review (and optionally refine) the surface descriptor and/or to guide the design of a dental prosthesis.

As shown in FIG. 2, the gingival mapping system 200 includes a computing system 5 including at least one processor and an imaging system 10 including at least one image sensor. Although shown as separate elements, it should be understood that the imaging system 10 and computing system 5 may be provided as a combined imaging and mapping system.

The computing system 5 can be implemented using one or more processors such as a specialized or general purpose microprocessor. The processor(s) control the operation of the computing system 5 and in general can include any suitable processor such as a microprocessor, controller, digital signal processor, field-programmable gate array, application-specific integrated circuit, microcontroller, or other suitable computer processor that can provide sufficient processing power, depending on the desired configuration, purposes, and requirements of the system 200.

The computing system 5 can include the one or more processors, a power supply, memory, and a communication module operatively coupled to the processor and to the system imaging system 10. The memory can include RAM, ROM, one or more hard drives, one or more flash drives or some other suitable data storage elements such as disk drives, etc. Optionally, the computing system 5 can be operatively coupled to at least one input device (e.g., a pushbutton keyboard, mouse, touchscreen, foot pedal, microphone and the like), and at least one output device (e.g., a display screen, a speaker etc.).

The computing system can be configured to communicate with the imaging system 10 in a wired or wireless manner. The computing system 5 can also be configured to perform various aspects of the systems and methods described herein. For example, the computing system 5 can be configured to perform methods of mapping a gingival surface methods (such as the example method 300 described herein below) and methods for mapping gingival surface locations into a jaw coordinate frame (such as the example method 400 described herein below).

The memory may store one or more applications for execution by the one or more processors. Applications may correspond to software modules comprising computer executable instructions to perform processing for the functions described below. For example, a gingival surface mapping application may be installed on the computing system 5. References to acts or functions by the computing system 5 imply that the processor is executing computer-executable instructions (e.g., a software program such as a gingival surface mapping application) stored in memory.

The memory may also include non-volatile data storage. The processor may execute applications, computer readable instructions or programs. The applications, computer readable instructions or programs may be stored in the memory. The memory can also store other data related to system 200 (e.g. calibration data for the mapping tool 30) and/or the process of mapping a gingival surface (e.g. a jaw coordinate frame, gingival surface coordinate sets, object-specific mappings, geometrical gingival surface descriptors etc.).

The imaging system 10 can be provided by a pose-tracking system, such as MicronMapper by ClaroNav Inc. The pose-tracking system can include one or more image sensors (e.g. a camera) and associated pose determination methods (e.g. software programs stored on a non-transitory storage medium and a processor operable to execute the software programs) capable of determining the pose (location and orientation) of spatially trackable objects (e.g. reference objects 20/42 and/or mapping tool 30) captured by the one or more image sensors. The pose-tracking system can determine the pose of the spatially trackable objects in an image sensor coordinate frame 11.

The one or more image sensors can be provided by a stereoscopic camera system, i.e., including two (or more) lens and image sensor sub-assemblies. However, the one or more image sensors can include a different number of image sensors, such 1, 3 or 4 arranged to determine the pose of spatially trackable objects.

The imaging system 10 may include one or more processors configured to perform pose determination methods on image data captured by the imaging system 10. Alternatively or in addition, the pose determination methods may be performed by the computing system 5. Optionally, the imaging system 10 may omit any processing functionality (other than that necessary to capture the image data and provide it to the computing system 5).

The system 200 can also include a mapping tool 30. The mapping tool 30 can be a handheld tool that is usable to contact sample locations along the gingival surface 40. The mapping tool 30 can include a locator tip 31. The locator tip 31 can be used to contact a precise sample location 60 along the gingival surface 40.

The mapping tool 30, and the locator tip 31 of the mapping tool 30, can also be spatially trackable (i.e. the pose of the locator tip 31 can be determined based on visible markers 34 displayed on the mapping tool 30). That is, the mapping tool 30 can include trackable optical markings 34 that are identifiable by the imaging system 10 and usable to determine the pose of the mapping tool 30. This can allow the location of the locator tip 31 to be determined precisely based on its fixed known pose in a coordinate frame of mapping tool 30.

As shown in the example of FIG. 2, the mapping tool 30 can include trackable optical markings 34 usable to determine a pose of the mapping tool 30. The precise location of the tip 31 (and thus a sample location 60 in contact with the tip 31) can then be determined based on the pose of the mapping tool 30 in which it is fixed.

The tip 31 has an associated coordinate frame 35. The imaging system 10 and/or computing system 5 can store tip calibration data usable to define a tip mapping between the coordinate frame of the trackable optical markings 34 and the coordinate frame 35 of the locator tip 31. An image of the mapping tool 30, and in particular the optical markings 34, can be used to determine the location of the tip 31 in the 3D coordinate frame 11 of the imaging system 10.

The system 200 can also include, or operate in conjunction with, a plurality of spatially trackable reference objects 20 and 42. Each reference object 20/42 can be spatially trackable (i.e. the pose of a given reference object 20/42 can be determined based on visible markers provided on the reference object 20/42). Each reference object 20/42 can include trackable optical markings that are identifiable by the imaging system 10 and usable to determine the pose of the respective reference object 20/42.

The imaging system 10 can define a coordinate frame for each reference object 20/42 (object coordinate frames 15) and the mapping tool 30 (tool coordinate frame 35). The imaging system 10 can also determine real-time coordinate mappings (rotation and shift) between the object coordinate frames 15 and/or tool coordinate frame 35 and the imaging system coordinate frame 11 (e.g. from image data that captures the tool optical markings and the optical markings for one or more reference objects).

The imaging system 10 and/or computing system 5 can also determine a real-time mapping between any two coordinate frames of the detected reference objects 20/42 and the mapping tool 30 (and thereby the tip 31) by concatenation and inversion of the mappings between the imaging system coordinate frame 11 and the respective coordinate frames being mapped to one another. When the imaging system 10 captures image data including one or more reference objects 20/42 and the mapping tool 30, the coordinate mappings between a given coordinate frame 15 and another coordinate frame 15 or the tool coordinate frame 35 can be readily determined. This can enable the position of the mapping tool tip 31 to be defined in a consistent jaw coordinate frame 50. Thus, the coordinates (also referred to as a gingival surface coordinate set) for multiple sample locations 60 along the gingival surface 40 can be defined in the same jaw coordinate frame 50. The locations of any mounting element reference objects 20 can also be defined using reference object coordinate sets in the same jaw coordinate frame 50.

Each reference object 20/42 can be maintained in a fixed spatial relationship to the patient's jaw. Each reference object 20/42 can be rigidly coupled (directly or indirectly) to the bone of the patient's jaw to maintain that reference object 20/42 in the fixed spatial relationship. For example, a reference object 20 can be rigidly affixed to a mounting element 12 embedded along the gingival surface 40 (i.e. to a prothesis coupling region of a dental implant assembly). Alternatively or in addition, the reference objects can be rigidly coupled to a tooth or screw that is rigidly affixed to the jawbone.

Alternatively or in addition, an external reference object 42 may be rigidly attached to the jawbone, for example using a configurable arm 43 screwed to the jawbone. The external reference object 42 can then be used to track the pose of the patient's jaw (and thus allow the sample location 60 coordinate sets to be defined in the jaw coordinate frame) even when reference objects 20 are missing or hidden from the images captured by the imaging system 10.

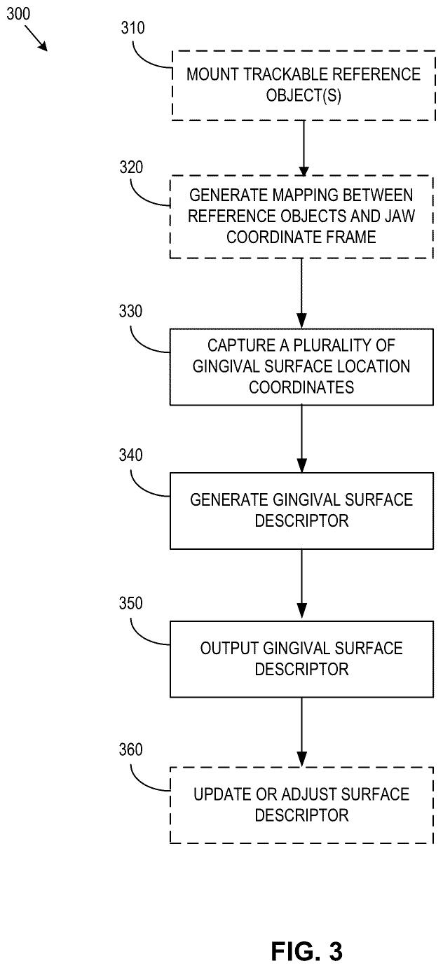

Referring now to FIG. 3, shown therein is an example method 300 for mapping a gingival surface. The method 300 can be implemented using a gingival mapping system, such as the example system 200 shown in FIG. 2. Method 300 is an example of a mapping method in which the gingival surface of a patient's jaw is mapped using at least one spatially trackable reference object in a fixed spatial relation to the jaw and a spatially trackable mapping tool.

Optionally at 310, one or more spatially trackable reference objects can be mounted to one or more locations in the patient's mouth. The spatially trackable reference objects can be mounted in such a manner that they maintain a fixed spatial relationship with the patient's jaw.

For example, reference objects 20 can be mounted to mounting elements 12 (e.g. multi-unit abutments) that are already positioned within the patient's mouth in a fixed spatial relationship with the patient's jaw. The reference objects 20 may also be mounted to other fixed elements within the patient's mouth, such as teeth and/or screws. This may involve affixing trackable optical markings to the fixed elements within the patient's mouth for the duration of the mapping process. Optionally, the optical markings may be removed once the mapping process is completed while leaving the fixed elements in place within the patient's mouth.

Alternatively or in addition, one or more external reference objects 42 can be rigidly coupled to the patient's jaw. The external reference object 42 may be positioned at a location outside the patient's mouth. This may allow the reference object 42 to be visible even if the interior of the patient's mouth is obscured during the mapping process.

The external reference object 42 can be affixed to the patient's jaw using a fixed coupling that extends from the patient's mouth to a location outside their mouth. For example, an arm 43 can be rigidly fixed (e.g. screwed) to the patient's jawbone. The arm 43 can provide a rigid coupling that maintains the external reference object 42 in a fixed spatial relationship with the jawbone. Optionally, the arm 43 and external reference object 42 can then be removed after the mapping process is complete.

Optionally at 320, an object-specific mapping can be determined for each spatially trackable reference object. The object-specific mapping can define a mapping between the object coordinate frame 15 of that spatially trackable reference object 20/42 and the jaw coordinate frame 50. For example, the mapping from the object coordinate frame 15 to the jaw coordinate frame 50 can be determined by determining the pose of the spatially trackable reference object 20/42 using a dental photogrammetry system (which may include imaging system 10).

The jaw coordinate frame 50 can be selected to provide a consistent coordinate frame to which each reference object 20/42 (and the mapping tool 30) can be mapped. For example, the jaw coordinate frame 50 may be selected to be one of the coordinate frames 15 of the reference objects 20. Coordinates obtained in frames 15 of other reference objects 20/42 can then be mapped to that jaw coordinate frame 50 for further processing and storage. More generally, the jaw coordinate frame 50 can be defined to be any suitable coordinate frame that remains in a substantially fixed spatial relationship to the jaw bone throughout the entire mapping process.

The dental photogrammetry mapping process may involve obtaining multiple samples of one or more reference objects 20/42. Accordingly, each sample can be mapped into the jaw coordinate frame 50 and then added or averaged with prior samples to reduce measurement noise and fill in reference objects missing from prior samples. This can provide mounting element coordinate sets for each of the mounting elements 12 in the patient's mouth in cases where the reference objects 20 are provided by optical markings affixed to the mounting elements 12.

At 330, a plurality of gingival surface coordinate sets can be captured. Each gingival surface coordinate set can be captured when the mapping tool tip 31 is in contact with a corresponding gingival surface location 60 on the gingival surface 40.

The plurality of gingival surface coordinate sets can include a plurality of crestline coordinate sets. Each crestline coordinate set can be defined based on a gingival surface location 60 along a crestline 65 of the gingival surface 40.

As dental prosthetics may mostly contact the crestline 65, the plurality of gingival surface coordinate sets may include a minimum number of crestline coordinate sets to ensure that the crestline 65 is mapped with sufficient accuracy. For example, the plurality of gingival surface coordinate sets can include at least four gingival surface coordinate sets corresponding to at least four gingival surface locations 60 along a crestline 65 of the gingival surface 40 (i.e. at least four crestline coordinate sets).

The plurality of gingival surface coordinate sets can be defined in the coordinate frame 50 of the jaw. This can require mapping the gingival surface locations 60 into the jaw coordinate frame 50.

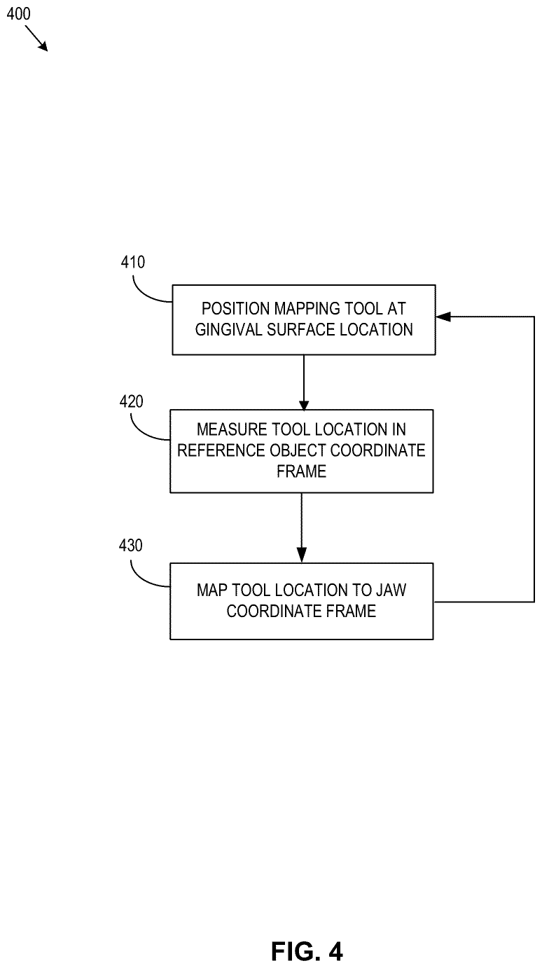

Referring now to FIG. 4, shown therein is an example method 400 for mapping a gingival surface location 60 to a jaw coordinate frame 50. The method 400 can be implemented using a gingival mapping system, such as the example system 200 shown in FIG. 2. Method 400 is an example of a process for mapping a gingival surface location 60 to a jaw coordinate frame 50 using a mapping tool 30 and one or more reference objects in a fixed spatial relationship with the jaw.

At 410, the mapping tool 30 can be positioned with the locator tip 31 at a gingival surface location 60. A user can manually manipulate the mapping tool 30 such that tip 31 rests at that gingival surface location 60.

At 420, the location of the mapping tool 30 can be measured in the coordinate frame of a reference object 20/42. The imaging system 10 can acquire an image of the mapping tool 30 and at least one of the reference objects 20/42 while the mapping tool 30 is in contact with the corresponding gingival surface location 60 on the gingival surface 40 (a gingival surface image).

Optionally, a gingival surface image can be captured automatically by the imaging system 10 in response to detecting that the locator portion 31 is in a static position for a predefined motionless period. For example, the pose of tip 31 can be automatically recorded in response to the imaging system 10 detecting that the tip 31 is not moving within jaw coordinate frame 50 for a predefined minimum amount of time, for example 0.5 seconds.

Alternatively or in addition, a gingival surface image can be captured in response to the imaging system 10 receiving a user input to actuate the image capture system. For example, the user may provide a voice signal and/or activate an input button (e.g. a foot pedal) to actively signal to the imaging system 10 to capture an image of the pose of the tip 31.

Optionally, the imaging system 10 can be configured to output an image captured feedback alert indicating that the gingival surface image was captured. For example, the imaging system 10 can provide an audio and/or visual feedback to inform the user that the gingival surface location was recorded. This can indicate to the user that the mapping tool 30 can be moved to another location 60. This may be particularly useful where the imaging system 10 is configured to automatically record an image of the mapping tool 30 in response to a predefined motionless period, e.g. to inform the user that a surface location has been captured and also to identify when an image may have been captured inadvertently. This can allow the user to progress to a new gingival surface location and/or to provide an input indicating that the previous image was capture erroneously.

At 430, the pose of tip 31 can be mapped into the jaw coordinate frame. The location of the tip 31 can be determined as an object reference surface coordinate set based on the image acquired at 420. The object reference surface coordinate set can be defined in the object coordinate frame of the reference object 20/42 visible within the image acquired at 420. The gingival surface coordinate set can then be determined by mapping the object reference surface coordinate set from the object coordinate frame into the jaw coordinate frame 50. The mapping from an object coordinate frame into the jaw coordinate frame 50 can be determined based on an object-specific mapping for the reference object visible within the image acquired at 420 (e.g. determined at 320).

Referring again to FIG. 3, at 330, the steps of method 400 may be repeated until a desired plurality of coordinate sets have been obtained. In some cases, a plurality of spatially trackable reference objects 20/42 are coupled to the bone of the patient's jaw. One or more subsets of the reference objects 20/42 can be used to capture the plurality of gingival surface coordinate sets (i.e. in different iterations of method 400) as long as all the surface coordinate sets captured can be mapped to the shared jaw coordinate frame 50.

At 340, a geometrical gingival surface descriptor can be computed from the plurality of gingival surface coordinate sets captured at 330. The gingival surface descriptor can be defined to approximate intermediary portions of the gingival surface between the gingival surface locations 60 corresponding to the plurality of gingival surface coordinate sets.

The geometrical gingival surface descriptor may be computed once the user has captured a minimum number of coordinate sets corresponding to different gingival surface locations 60. The minimum number of coordinate sets may vary depending on the particular implementation, although it may typically be about 4 locations.

Various techniques can be used to compute a surface descriptor from a plurality of sample points. For example, various techniques are surveyed, for example, in “Survey on 3D Surface Reconstruction”, January 2016 Journal of Information.

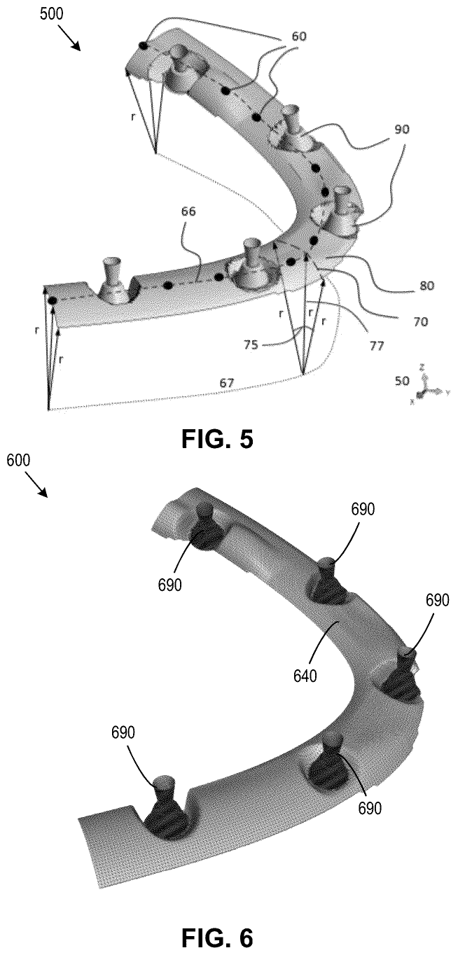

An example method for computing a surface descriptor will now be described with reference to FIG. 5. The gingival surface descriptor 500 can be defined to include a plurality of mapped crestline surface locations corresponding to at least four gingival surface locations 60 along a crestline 65 of the gingival surface 40. The intermediary portions of the gingival surface 40 can be approximated using a modelled crestline curve 66 that is determined to pass through or proximate to each of the mapped crestline surface locations 60. The modelled crestline curve 66 can be computed as a smoothed curve that passes approximately through locations 60.

The surface descriptor 500 can also be defined to provide an approximate crestline strip using a shifted version of the modelled crestline curve. The shifted crestline curve can be determined by determining a crestline plane to fit the mapped crestline surface sample locations 60. The crestline plane can be determined using regression.

The shifted crestline curve 67 can be generated by shifting the crestline curve 66 in a shift direction perpendicular to the crestline plane by a predefined radius r. The shift direction can be selected to be in a direction substantially opposite to the direction from which the reference objects 20 extend away from the crestline 65 (or opposite to the direction of the pointer tip 31 relative to the surface locations 60 when locations 60 where recorded).

The value of the radius r can be selected to provide a reasonable curvature to the cross section 70 of the crestline strip. For example, the radius may be selected to be in the range of about r=8 mm to about r=12 mm. The particular value of r may be selected to reflect the curvature of a given patient's crestline and/or a standard expected curvature.

A crestline strip width can then be defined for the gingival surface descriptor. The crestline strip width may be selected to reflect the width of a given patient's crestline and/or a standard expected crestline strip width. For example, the crestline strip width may be selected in a range of about 8 mm to about 12 mm. The crestline strip width can be used to determine a surface fanning angle 75 from each location along the shifted crestline curve 67.

The gingival surface descriptor can be defined based on the shifted crestline curve 67, the surface fanning angle 75 and the predefined radius r. For example, a plurality of shifted curve locations along the shifted crestline curve 67 can be determined. For example, the plurality of shifted curve locations can be determined by sampling the shifted crestline curve 67 in a plurality of crestline steps. The step size of the crestline steps may be in the range of about 0.5 mm, however the step size can vary depending on the granularity desired in a given implementation.

A plurality of fanning angle steps can be determined along the fanning angle 75 at the predefined radius from the shifted crestline curve 67. That is, the fanning angle 75 can be also divided into steps of a similar size at distance r (arcsin(step/r)) from the shifted crestline curve 67.

For each combination of crestline step and fanning angle step, a gingival surface distance value from the shifted crestline curve 67 can be defined. The gingival surface distance value may be initialized to be approximately equal to the radius r, although the gingival surface distance value may subsequently be modified to accommodate additional sample locations. The plurality of gingival surface distance values defines a ridge 3D coordinate system (curve step, angular step, distance) usable to describe the gingival surface (e.g. gingival surface descriptor 80). The ridge representation can be translated into a polygon mesh (e.g. a standard triangulated mesh) to facilitate data storage and display by connecting neighbors at integer indexes, as illustrated in FIG. 6.

Optionally, the crestline strip 82 can be defined as a flattened strip (at least initially) when mapping the gingival surface 40. Alternatively, the crestline strip 82 can be defined to provide a slightly curved strip (at least initially) when mapping the gingival surface 40. In either case, the crestline strip 82 may be subsequently refined as additional locations on the surface 40 are sampled (e.g. in step 360 described herein below).

The geometrical gingival surface descriptor 500 can also be defined to include geometrical representations 90 of the prosthesis coupling regions 12. A plurality of coupling region poses can be determined in the coordinate frame of the jaw (e.g. as part of steps 310 and 320). The plurality of coupling region poses can correspond to a plurality of a dental prosthesis coupling regions (e.g. MUAs) of a dental implant assembly.

A user can select a shape 90 to represent each implant coupling region 12 (typically an MUA). The shape 90 can be selected to be the desired shape of the coupling surface region in the intaglio of the prosthesis. However, a user can adjust the particular shape 90 as desired or select any other shape. A stored surface descriptor of the shape 90 can be transformed into the jaw coordinate frame 50 using the object-specific mapping determined at step 320. The surface descriptor 80 in a neighboring region around each shape 90 (e.g. a ring-like region) can be modified to merge with the edges of the shape 90, as shown in FIGS. 5 and 6 (see e.g. rendered shapes 690 and rendered surface 640).

At 350, the geometrical gingival surface descriptor can be output. For example, the geometrical gingival surface descriptor can be output to a computer-aided design program to be used to guide the design of an intaglio surface of a dental prothesis. Alternatively or in addition, the geometrical gingival surface descriptor can be stored in non-transitory storage memory for later review and/or use.

Optionally, the geometrical gingival surface descriptor can be output to a display. For example, a 3-dimensional digital gingival surface map 600 can be rendered from the geometrical gingival surface descriptor as shown in FIG. 6. The 3-dimensional digital gingival surface map may then be displayed to a user (e.g. a dentist or oral surgeon). The user may review the 3-dimensional digital gingival surface map to determine whether the map is sufficiently refined or whether coordinate sets corresponding to additional sample locations should be captured.

Optionally at 360, the geometrical surface descriptor can be updated and/or adjusted. Additional gingival surface locations may be mapped to update or refine the surface descriptor determined at 340. The geometrical surface descriptor may then be re-computed or smoothed to include the gingival surface coordinate sets from the additional gingival surface locations.

For example, an initial geometrical gingival surface descriptor may be computed at 340. Subsequently, at least one additional gingival surface coordinate set in the coordinate frame of the jaw can be captured (e.g. using method 400). An updated geometrical gingival surface descriptor can be computed by updating the initial geometrical gingival surface descriptor using the at least one additional gingival surface coordinate set.

The process of updating the geometrical gingival surface descriptor may continue iteratively until a user is satisfied with the result. For example, a user may continue to capture crestline coordinate sets until they determine by inspection of the display that the rendered region spans the full extent of the crestline region needed to design the prosthesis.

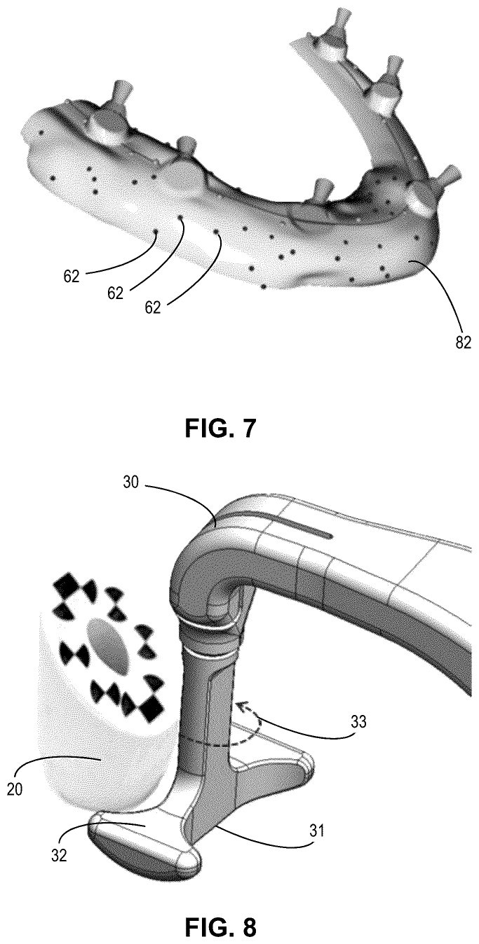

A user may also select to expand and refine the surface descriptor by collecting additional points 62 on or beside the crestline strip. For example, subsequent to displaying the rendered 3-dimensional digital gingival surface map at least one additional gingival surface image can be captured. Each additional gingival surface image can correspond to an additional surface sample location 62 along the gingival surface. Each additional gingival surface image can be used to map the position of an additional surface sample location 62 into a gingival surface coordinate set defined in the jaw coordinate frame 50 (e.g. using method 400). The gingival surface descriptor can then be updated to include the at least one additional gingival surface coordinate set (e.g. as shown in FIG. 7).

When updating the geometrical surface descriptor, new sample locations may be blended into the existing surface descriptor rather than re-computing the entire surface descriptor. For example, an additional location 62 can be mapped from jaw coordinate system 50 to the ridge representation (curve step, angular step, distance) coordinate system. An elliptical region around that additional location 62 can be blended with the distances already stored to maintain surface smoothness (e.g. maintain continuity in first and second derivatives). The blending may also be done directly on the triangular mesh representation using many known mesh editing algorithms well known in the art, for example as implemented in the open-source mesh editing program MeshLab (www.meshlab.net).

In the example shown in FIG. 2, the locator tip 31 can be provided in the form of a pointer. However, when mapping gingival surface locations 60 following an implant placement surgery, a pointed pointer tip 31, as illustrated in FIG. 2, may sink into cracks between gingiva flaps or push loose gingiva into underlying sockets left by extracted teeth.

Referring now to FIG. 8, shown therein is an example of a mapping tool 30 in which the locator tip 31 has been modified to avoid undesirable outcomes that may result from using a pointed locator tip 31. As shown in FIG. 8, the mapping tool 30 includes an extended surface contact section 32 shaped to extend across an extended section of the gingival surface when the surface locator portion 31 is positioned at a given gingival surface location.

The extended surface contact section 32 can be provided as an extending plate that is sized to extend across the gingival ridge when the locator portion 31 is positioned to contact the gingival surface. For example, the plate may have a length in a range of about 8-15 mm.

The plate may be provided in various shapes, such as a cylindrical or hourglass-shaped plate 32. The plate can be arranged by a user to lie laterally across the gingival ridge and to fit near to, and between, reference objects 20, even when there is minimal space between them, as illustrated in FIG. 8.

Optionally, the extended surface contact section 32 can be rotatable while maintaining a fixed relationship between the surface locator portion 31 and the optically trackable markers on the mapping tool 30. This can allow a user to rotate the plate to fit near to and between the reference objects 20.

To enable the extended surface contact section 32 to rotate, the mapping tool 30 can include a single longitudinal rotation axis 33. This may provide a small and simple rotational mechanism for the mapping tool 30.

Alternatively, the extended surface contact section 32 may be rotatable around a ball joint to provide a further degree of rotational freedom. This may allow the mapping tool 30 to adapt to objects and perturbations along the gingival surfaces.

While the above description provides examples of one or more processes or apparatuses or systems, it will be appreciated that other processes or apparatuses or systems may be within the scope of the accompanying claims.

It will be understood that the embodiments described in this disclosure and the module, routine, process, thread, or other software component implementing the described methods/processes/frameworks may be realized using standard computer programming techniques and languages. The present application is not limited to particular processors, computer languages, computer programming conventions, data structures, and/or other such implementation details. Those skilled in the art will recognize that the described methods/processes may be implemented as a part of computer-executable code stored in volatile or non-volatile memory, as part of an application-specific integrated chip (ASIC), etc.

As will be apparent to a person of skill in the art, certain adaptations and modifications of the described methods/processes/frameworks can be made, and the above discussed embodiments should be considered to be illustrative and not restrictive.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be re-visited.

We claim:

1. A method of mapping a gingival surface of a patient's jaw using at least one spatially trackable reference object in a fixed spatial relation to that jaw and a spatially trackable mapping tool, the method comprising:
capturing a plurality of gingival surface coordinate sets in a coordinate frame of the jaw, wherein each of the gingival surface coordinate sets is captured when the mapping tool is in contact with a corresponding gingival surface location on the gingival surface; and
computing a geometrical gingival surface descriptor from the plurality of gingival surface coordinate sets.

2. The method of claim 1, wherein the plurality of gingival surface coordinates comprises at least four gingival surface coordinate sets corresponding to at least four gingival surface locations along a crestline of the gingival surface.

3. The method of claim 1, wherein each spatially trackable reference object is rigidly coupled to the bone of the patient's jaw.

4. The method of claim 1 wherein a plurality of spatially trackable reference objects are coupled to the bone of the patient's jaw and wherein two different subsets of the reference objects are used in capturing the plurality of gingival surface coordinate sets.

5. The method of claim 3, wherein at least one spatially trackable reference object is coupled to a prothesis coupling region of a dental implant assembly.

6. The method of claim 1, further comprising:
capturing a plurality of coupling region poses in the coordinate frame of the jaw, the plurality of coupling region poses corresponding to a plurality of a dental prosthesis coupling regions of a dental implant assembly; and
defining the geometrical gingival surface descriptor to include geometrical representations of the prosthesis coupling regions.

7. A system for mapping a gingival surface of a patient's jaw using at least one spatially trackable reference object in a fixed spatial relation to that jaw and a spatially trackable mapping tool, the system comprising:
at least one image sensor; and
at least one processor;
wherein the at least one image sensor is configured to capture a plurality of gingival surface coordinate sets in a coordinate frame of the jaw,
wherein each of the gingival surface coordinate sets is captured when the mapping tool is in contact with a corresponding gingival surface location on the gingival surface; and
the at least one processor is configured to compute a geometrical gingival surface descriptor from the plurality of gingival surface coordinate sets.

8. The system of claim 7, wherein the plurality of gingival surface coordinates comprises at least four gingival surface coordinate sets corresponding to at least four gingival surface locations along a crestline of the gingival surface.

9. The system of claim 7, wherein each spatially trackable reference object is rigidly coupled to the bone of the patient's jaw.

10. The system of claim 7 further comprising a plurality of spatially trackable reference objects coupled to the bone of the patient's jaw; and wherein the at least one image sensor is configured to capture a first gingival surface coordinate set using a first subset of the reference objects and to capture a second gingival surface coordinate set using a second subset of the reference objects.

11. The system of claim 9, comprising at least one spatially trackable reference object coupled to a prothesis coupling region of a dental implant assembly.

12. The system of claim 7, wherein:
the at least one image sensor is configured to capture a plurality of coupling region poses in the coordinate frame of the jaw, the plurality of coupling region poses corresponding to a plurality of a dental prosthesis coupling regions of a dental implant assembly; and
the at least one processor is configured to define the geometrical gingival surface descriptor to include geometrical representations of the prosthesis coupling regions.

13. The system of claim 7, wherein the at least one processor is configured to define the gingival surface descriptor to approximate intermediary portions of the gingival surface between the gingival surface locations corresponding to the plurality of gingival surface coordinate sets.

14. The system of claim 13, wherein the at least one processor is configured to define the gingival surface descriptor to include a plurality of mapped crestline surface locations corresponding to at least four gingival surface locations along a crestline of the gingival surface, and the intermediary portions of the gingival surface are approximated using a modelled crestline curve determined to pass through or proximate to each of the mapped crestline surface locations.

15. The system of claim 7, wherein the at least one processor is configured to compute the geometrical gingival surface descriptor by:
computing an initial geometrical gingival surface descriptor;
subsequently receiving at least one additional gingival surface coordinate set in the coordinate frame of the jaw; and
computing an updated geometrical gingival surface descriptor by updating the initial geometrical gingival surface descriptor using the at least one additional gingival surface coordinate set.

16. The system of claim 7, wherein the at least one processor is further configured to, for each spatially trackable reference object, determine an object-specific mapping between an object coordinate frame of that spatially trackable reference object and the jaw coordinate frame.

17. The system of claim 7, further comprising the mapping tool, wherein the mapping tool comprises a surface locator portion usable to contact the gingival surface, wherein the surface locator portion comprises an extended surface contact section shaped to extend across an extended section of the gingival surface when the surface locator portion is positioned at a given gingival surface location.

18. The system of claim 17, wherein the extended surface contact section is rotatable while maintaining a fixed relationship between the surface locator portion and an optically trackable marker on the mapping tool.

19. The system of claim 7, wherein the at least one processor is further configured to render a 3-dimensional digital gingival surface map from the geometrical gingival surface descriptor and display the 3-dimensional digital gingival surface map.

20. The system of claim 7, wherein the at least one processor is further configured to guide design of an intaglio surface of a dental prothesis using the geometrical gingival surface descriptor.

21. The system of claim 7, wherein the at least one image sensor is configured to capture the plurality of gingival surface coordinate sets by, for each gingival surface coordinate set, capturing an image of the spatially trackable mapping tool and at least one of the spatially trackable reference objects while the mapping tool is in contact with the corresponding gingival surface location on the gingival surface.

22. The system of claim 21, wherein the at least one image sensor is configured to capture the plurality of gingival surface coordinate sets by, for each gingival surface coordinate set:
determining an object reference surface coordinate set in an object coordinate frame of the at least one of the spatially trackable reference objects; and
determining the gingival surface coordinate set by mapping the object reference surface coordinate set from the object coordinate frame into the jaw coordinate frame.

23. A non-transitory computer readable medium storing computer-executable instructions for configuring one or more processors to perform a method of mapping a gingival surface of a patient's jaw using at least one spatially trackable reference object in a fixed spatial relation to that jaw and a spatially trackable mapping tool, the method comprising:
acquiring a plurality of gingival surface coordinate sets in a coordinate frame of the jaw, wherein each of the gingival surface coordinate sets is captured when the mapping tool is in contact with a corresponding gingival surface location on the gingival surface; and
computing a geometrical gingival surface descriptor from the plurality of gingival surface coordinate sets.
